(19) United States
(12) Patent Application Publication
(10) Pub. No.: US 2023/0259859 A1
(43) Pub. Date: Aug. 17, 2023

(54) SUSTAINABILITY FOOTPRINT DERIVATION FRAMEWORK

(71) Applicant: SAP SE, Walldorf (DE)

(72) Inventors: Ramana Mohanbabu, Bangalore (IN); Rupert Lange, Walldorf (DE); Stefan Feickert, Birkenau (DE)

(73) Assignee: SAP SE, Walldorf (DE)

(21) Appl. No.: 17/672,239

(22) Filed: Feb. 15, 2022

(51) Int. Cl. G06Q 10/06

(52) U.S. Cl. CPC G06Q 10/06375; G06Q 10/06393

(57) ABSTRACT

Systems and processes for generating and managing derivation definitions for calculating sustainability footprints are provided. In a method for generating derivation definitions for calculating footprints, inputs, rulesets, and/or coded processes are determined for the derivation definition. A sequence order for applying the rulesets and/or coded processes is determined for the derivation definition, and the derivation definition is stored in a repository for selection to calculate sustainability footprints.

### BACKGROUND

The impact of an organization and associated operations on the environment may be tracked through the use of sustainability footprints, which may include carbon footprints, water footprints, ecological footprints, and/or other footprints. The sustainability footprints may be used to evaluate implications of strategic decisions, track progress toward sustainability goals, and ensure compliance with regulations, among other applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In summary, the detailed description is directed to various innovative technologies for managing, processing, and generating display information relating to sustainability footprint calculations. In some examples, the disclosed technologies can be implemented as method performed by a computer. One or more rulesets to be applied to input data corresponding to operations of an organization are configured to generate a derivation definition for a sustainability footprint calculation relating to the operations. The derivation definition is updated by configuring one or more coded processes to be applied to the input data, and a sequence order is determined for the configured one or more rulesets and one or more coded processes for the derivation definition. The derivation definition is stored in a repository for retrieval by a footprint calculation agent or engine configured to apply the one or more rulesets and one or more coded processes to the input data in the determined sequence order to calculate and output an indication of a sustainability footprint relating to the operations to a graphical user interface.

In some examples, the disclosed technologies can be implemented as computer-readable media storing instructions which, when executed by one or more hardware processors, cause the hardware processors to perform the following actions. First user input (e.g., from a customer of a management system’s software for footprint calculations) is received via a graphical interface, the first user input identifying input data including a set of emissions factors relating to one or more products and activity data including one or more categories of data relating to operations of an organization. Second user input (e.g., from a management system that has prepackaged rulesets to be applied for a specific product footprint calculation) is received via the graphical user interface, the second user input configuring one or more rulesets to be applied to the input data and further specifying a sequence order for the configured one or more rulesets. The first and second user input is computer processed to generate a derivation definition for a sustainability footprint calculation, the derivation definition configured to trigger the one or more rulesets to be applied to the input data in the sequence order to calculate a sustainability footprint relating to the operations of the organization. The derivation definition is stored in a repository for retrieval by a footprint calculation agent or engine configured to calculate the sustainability footprint using the derivation definition and to output an indication of the sustainability footprint.

In some examples, the disclosed technologies can be implemented in a system including one or more hardware processors with coupled memory, and computer-readable media storing instructions executable by the one or more hardware processors. The instructions include first, second, third, fourth, and fifth instructions. The first instructions, when executed, cause a selection of input data including sustainability reference data, business activity data, or a combination of sustainability reference data and business activity data to be used for a sustainability calculation for an organization to be received via a first graphical user interface displayed on a first computing device. The second instructions, when executed, cause one or more rulesets and one or more coded processes, to be applied to the input data, to be configured based on user input received via the first graphical user interface displayed on the first computing device. The third instructions, when executed, cause a derivation definition for the sustainability calculation to be generated, the derivation definition including the one or more rulesets and one or more coded processes, and the derivation definition including instructions to perform the one or more rulesets and one or more coded processes in a sequence order based on further user input received via the first graphical user interface displayed on the first computing device. The fourth instructions, when executed, cause the derivation definition to be retrieved from the repository responsive to a request from a sustainability calculation agent or engine to cause the sustainability calculation agent or engine to apply the one or more rulesets and one or more coded processes to the input data in the sequence order to calculate and output an indication of a sustainability footprint to a second graphical user interface displayed on a second computing device.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an example framework for configuring and managing derivation definitions for calculating footprints in accordance with examples of the present disclosure.

FIG. 2 is a block diagram of an example structure of an assessment data object used for derivation definitions in accordance with examples of the present disclosure.

FIG. 3 is a flowchart of an example method for generating, managing, and applying derivation definitions to calculate footprints in accordance with examples of the present disclosure.

FIG. 4 is an example of a user interface for managing and generating derivation definitions in accordance with examples of the present disclosure.

FIG. 5 is a diagram of an example computer architecture for a system in which sustainability footprint calculation methodologies may be selected and applied to calculate sustainability footprints.

FIG. 6 is a diagram of a structure of an illustrative example of a derivation definition in accordance with examples of the present disclosure.

FIG. 7 is a diagram schematically depicting a computing environment suitable for implementation of disclosed technologies.

FIG. 8 is a diagram schematically depicting computing devices operating in conjunction with a computing cloud for implementation of disclosed technologies.

### DETAILED DESCRIPTION

### Introduction and Overview

Sustainability services may utilize efficient and fast algorithms for sustainability footprint (e.g., a carbon CO₂ footprint) calculations. These calculations may be related to individual value chain contributions of upstream processes like raw material processing and inbound transport, own processing like production or assembly of products, and downstream processes like outbound transport, product use, and product end of use. The calculated footprints may be used as a data basis for reducing direct or indirect emissions, and with that to reduce costs like carbon taxes. The scope of such footprint calculations is defined but not limited to the scopes defined by the Greenhouse Gas Protocol (GHG Protocol). These calculation algorithms are configured to cover the complex cases like multiple suppliers in upstream inbound activities, the accumulation of goods in the inventory, the supplier-unaware outbound flows in direct production, the downstream activities etc. The calculations may be based on various types of so-called Business Activity Metrics (BAM) like physical goods movement, extracted from business data sources. This data, being accumulated and aggregated in a defined way, combined with the sustainability reference factors (which are obtained from external and home systems in the form of sustainability impacts for various business activities), form the basis for corporate business activities footprint calculations. These results may then be used as a basis for sustainability scoring and footprint determination in general business processes like purchasing, material sourcing, production planning and optimization, Material Requirements Planning (MRP) and vendor selection, etc. and used for broader analytical reporting, including creation of a respective sustainability factors base.

However, existing approaches to assessing environmental footprint of any enterprise or products consumed and manufactured by an enterprise do not provide a consistent methodology which can be applied across different organizational boundaries of an enterprise at scale. These methodologies are often inconsistent because they are documented as derivation principles or approaches in the mind of Sustainability Business Experts or in documents or spreadsheets, thereby preventing automation of these environmental footprint derivation calculations and preventing re-use of the derivation methodology in a repeatable pattern across the different departments of an enterprise. An additional issue with assessing environmental footprint at scale using existing approaches is the absence of flexibility in applying a derivation methodology that is well suited for a given product, supplier, country, etc. and also choosing a methodology based on the value chain stage that is under scope of footprint assessment. However, offering the possibility to tailor or customize the derivation methodology often leads to inconsistent business rules being applied due to lack of coordination or losses in translation between the Sustainability Business Expert to the Information Technology (IT) expert who is responsible to customize the derivation methodology. The inability to scale from calculating the footprint of single plant of enterprise to multiple plants/enterprises or from calculating a subset of an operation like manufacturing or transport of one finished product to several thousand finished products is an additional problem addressed by the present disclosure.

The derivation methodology to be applied depends on the granularity and quality of primary and secondary data available in an enterprise. This can vary from enterprise to enterprise and also the methodology suited for calculating footprint for cradle to outbound gate of pre-chain can be different to the approach to be used for a company’s own operations. Hence a possibility to derive footprint bottom up on primary data, such as physical goods purchased, or top down on secondary data, such as utility bills from energy vendor, is missing in the solutions available in the market today. This is largely due to the inability to coordinate the primary and secondary data and correlate these footprint derivations back to the business scope of the footprint assessment.

This disclosure describes a new approach including footprint derivation methodologies that manage footprint calculations using a derivation framework including a central repository of derivation definitions. The central repository of derivation definitions may be decoupled from footprint assessments, allowing reuse of the derivations across multiple footprint assessments. The derivation according to the present disclosure may be a data enrichment function that can be used to enhance business activity data and/or elementary flow data based on logic expressed via user- or customer-configured rulesets or system-coded methods. The derivation may have a well-defined contract (e.g., technical interface and/or signature) with data objects as inputs, references, and results. Derivations may be reusable across multiple footprint assessment template variants, and a selected derivation definition version may be linked to a footprint assessment template for a footprint category and business activity combination to increase efficiency for users.

The disclosed approach provides flexibility in tailoring the behavior of a derivation definition through a configurable ruleset combined with pre-delivered coded methods. A ruleset may include a collection of rules, which are executed in a sequence when triggered by a derivation. Rulesets may be classified into search ruleset or calculation ruleset. Search rulesets may include one or more condition table rules, which are executed in a sequence. The execution sequence can be altered to provide a definitive search strategy. In this way, the disclosed approach allows for quick life cycle management and extensibility/tailoring for different end users. The above features of the disclosed approach may also decrease the cost (e.g., human and machine resources/time/monetary cost) of calculating the footprint at scale relative to other approaches. The above and additional details relating to the disclosed technologies are described further below.

### Example Framework

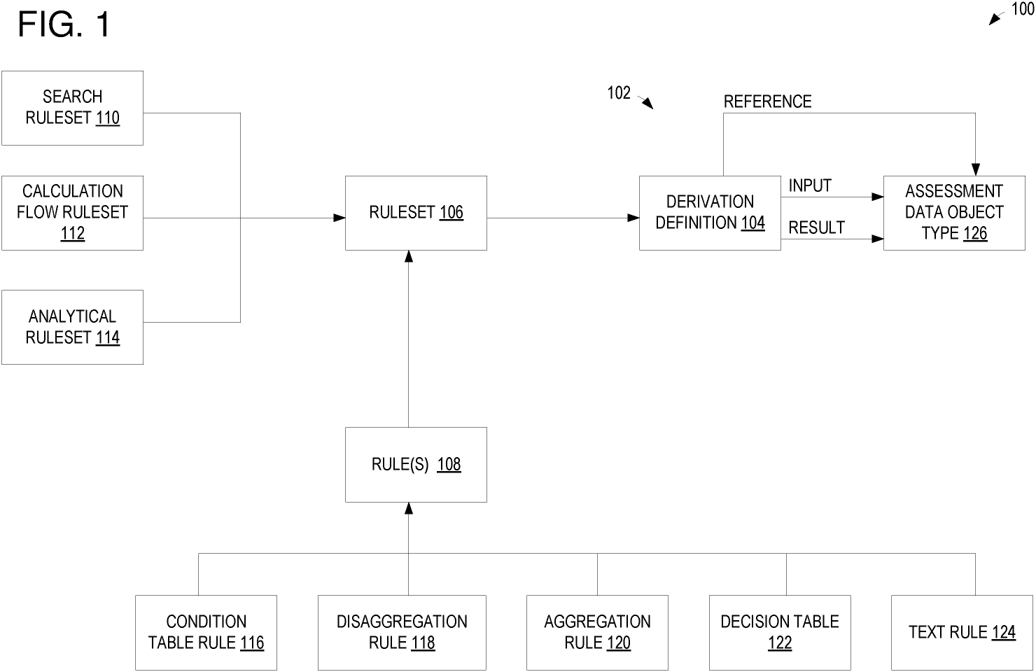

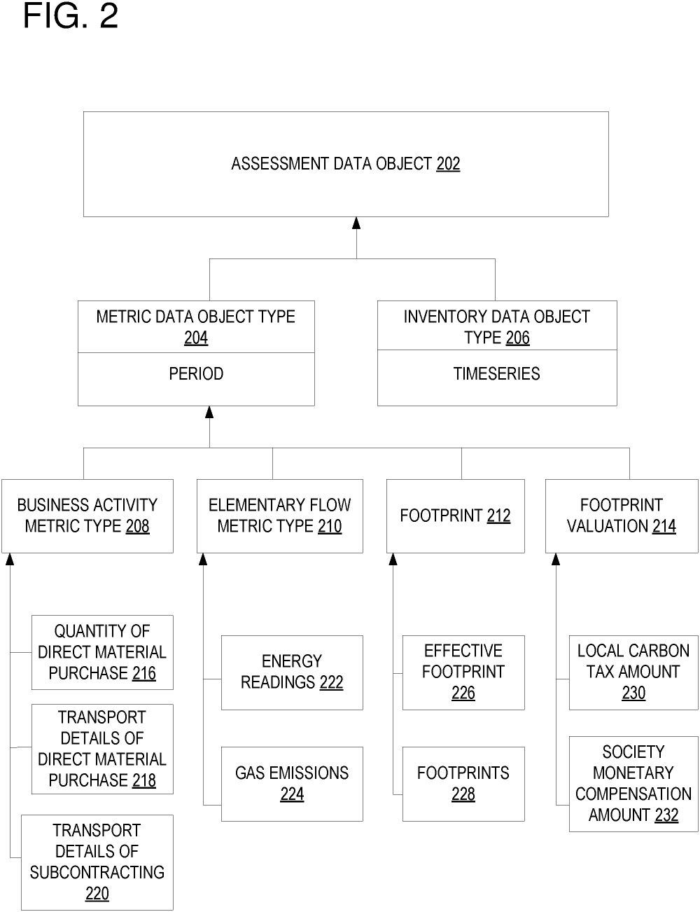

FIG. 1 schematically shows an example framework 100 for footprint derivations, which may be used to define derivations available for use in footprint assessments for one or more end users/organizations. For example, a derivation may be a data enrichment function (illustrated at 102) that can be used to enhance data in a dataset (e.g., data corresponding to operations of an organization usable to determine a footprint of the operations, examples of which are described in more detail below with respect to FIG. 2) based on logic expressed via customer-configured rulesets and/or managing system-coded methods. A central repository of derivation definitions may include multiple definitions having corresponding respective rulesets, such that a customer may select one or more derivation definitions to be used to process their data to determine footprints in a tailored manner. One or more selected derivation definition versions may be linked to a footprint assessment template derivation definition step, where each version may represent an immutable snapshot of the definition (e.g., where for any bug fixes or changes, a new version of the derivation is activated and/or released, rather than updating an existing version). Derivations may be reusable across multiple footprint assessment template variants. In this way, a customer/organization may configure different footprint assessments corresponding to different derivation definitions or combinations of derivation definitions for different types of footprint calculations (e.g., calculations having different scopes/time frames, relating to different plants/products, etc.).

The framework 100 allows flexibility in tailoring the derivation definition through a configurable ruleset 106. The ruleset 106 includes a collection of rules 108, which are executed in a sequence when triggered by a derivation. The ruleset 106 may be bound to one derivation definition, such that the ruleset is unique to that derivation definition or each derivation definition has a unique ruleset. As shown, the ruleset may be classified into a search ruleset 110, a calculation ruleset 112, or an analytical ruleset 114. Each type of ruleset may have a different runtime behavior and may be configured for a specified pattern of derivations.

For example, a search ruleset 110 may include one or more condition table rules 116, which are executed in a sequence. The execution sequence may be altered to provide a definitive search strategy. A condition table rule enables association of attributes and/or characteristics of business activity metric data with sustainability reference data at runtime. The condition table rule execution may stop at a first hit of a matching condition row in the condition table. Derivations with search rulesets may have a post-processing step implemented by a coded method (examples of which are describe below).

Calculation flow rulesets 112 may include one or more rules (other than condition table rules) which are executed in a sequence. For example, disaggregation rules 118 may be used to split an assessment template data object that is an input or reference to the derivation or a data object that is calculated intermediately in the ruleset to a target data object at a more granular dimension(s). Aggregation rules 120 may be used to merge an assessment template data object of type “Table,” which is an input or reference to the derivation into a data object at a lower granularity. Decision table rules 122 may be used to map data points with matching condition rows to calculate additional characteristics for the data points. Text rules 124 may include if/then rules that may be used to modify (e.g., append, update, and/or delete) an assessment template data object that is input to a derivation or intermediately computed within the ruleset.

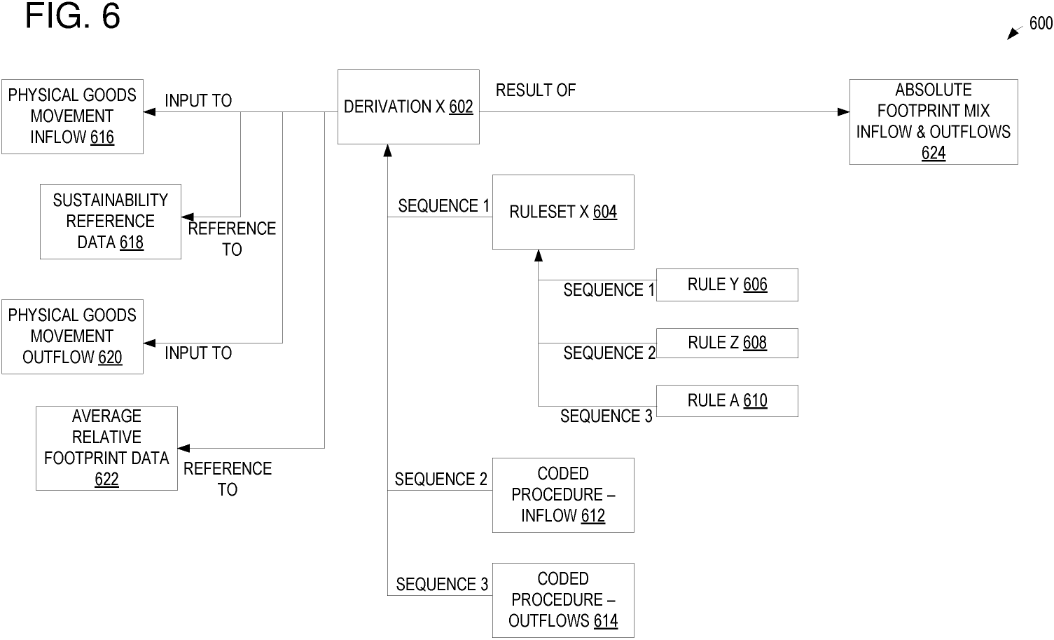

Analytical rulesets 114 may include specialized rulesets which can execute multiple rules with a same result type and return the union of each rule result as a final result to a footprint derivation. An illustrative example of an application of a ruleset to data according to a derivation definition is described below with respect to FIG. 6.

As described above, the derivation definition 104 is defined by the ruleset 106 to control how data is processed when the derivation definition is selected for footprint assessment. The derivation has a well-defined contract (e.g., technical interface and/or signature) with data objects (e.g., assessment data object type 126) as inputs, reference, and result, as shown in FIG. 1. The data object type 126 may include a data object that has a structural representation and/or metadata of data points that are used and/or derived in assessment runtime (e.g., when a footprint is calculated). FIG. 2 shows an example footprint assessment data object classification for data objects such as assessment data object type 126 of FIG. 1. Assessment data objects may be of a structure type or table type, and may be flat and/or nested. Assessment template data objects may be pre-delivered by a management system that manages the footprint derivation definitions and/or may include extensions provided by customers or partners. The assessment data objects may act as a business vocabulary for derivations to express business logic.

As shown in FIG. 2, the assessment data object 202 may include metric data object types 204, which may relate to an operational period of interest, and/or inventory data object types 206, which may relate to a timeseries. Metric data object types 204 may include business activity metric types 208, elementary flow metric types 210, footprints 212, and/or footprint valuations 214. Business activity metric types 208 may include data such as a quantity of direct material purchase 216, transport details (e.g., distance, mode, economic value, etc.) of direct material purchase 218, transport details (e.g., distance, mode, economic value, etc.) of subcontracting 220, and/or other types of business activity data. The business activity data may be defined for a period, company, plant, and/or supplier granularity in some examples.

Elementary flow metric types 210 may include data such as energy readings 222, which may be defined at period, company, plant, and/or product (or any sub-combination thereof) granularity, gas emissions data 224 (e.g., provided by a third party and/or environmental health and safety management system), which may be defined at period, company, and/or plant granularity, and/or other elementary flow data.

Footprint data 212 may include effective footprint data 226, which may be defined at period, product, plant, and/or customer (or any sub-combination thereof) granularity, and/or footprints 228, which may be defined at period, plant, and/or supplier granularity. Footprint valuation data 214 may include local carbon tax amount data 230 (e.g., at period and/or company granularity), society monetary compensation amount data 232 (e.g., at period, company, and/or plant granularity), and/or other valuation data relating to sustainability footprints.

### Example Method

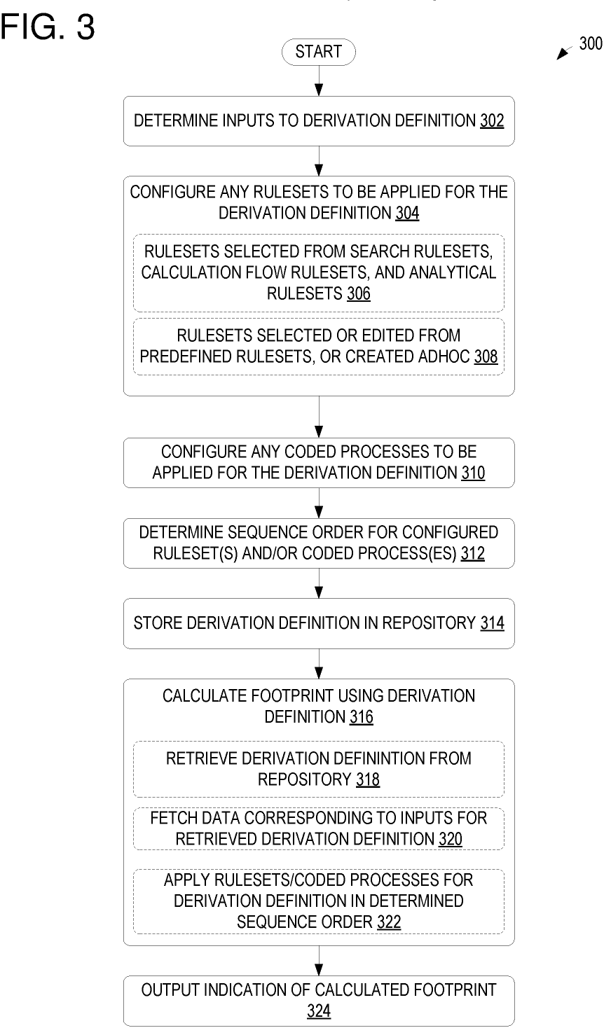

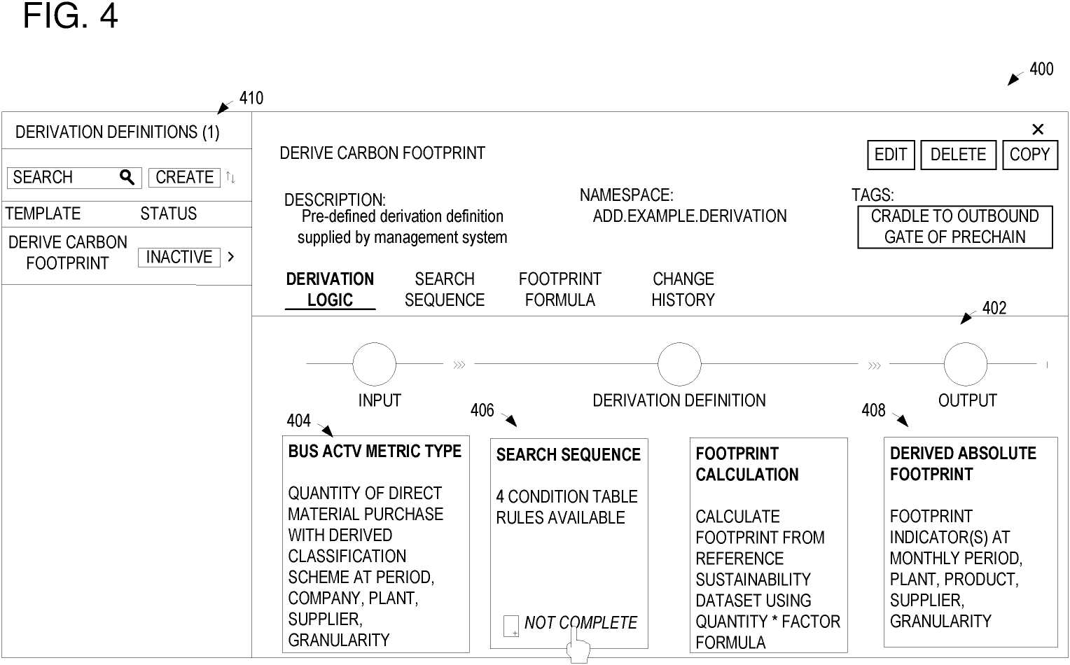

FIG. 3 is a flowchart of an example method 300 for illustrating a process sequence of deriving a derivation definition for use in footprint assessments. For example, method 300 may be performed by one or more components of a system, such as a computing system implementing the framework shown at 100 of FIG. 1. In some examples, at least a portion of method 300 may be performed using a user interface, such as the user interface described in more detail below with respect to FIG. 4. At 302, the method includes determining inputs to the derivation definition. For example, inputs may include business activity metrics or other data usable to determine a footprint relating to a selected product under assessment.

At 304, the method includes configuring any rulesets to be applied for the derivation definition. As indicated at 306, the rulesets may be selected from search rulesets, calculation rulesets, and analytical rulesets, as described in more detail with respect to FIG. 1. In other examples, additional or alternative types of rulesets may be available. As indicated at 308, the rulesets may be selected or edited from predefined or previously created rulesets, or may be created ad hoc. For example, as further described with respect to FIG. 1, rulesets may include one or more rules that are defined as being applied in a selected sequence order. Accordingly, the rules, parameters of the rules, and/or sequence of the rules may be determined and/or edited to configure the rulesets at 304.

At 310, the method includes configuring any coded processes to be applied for the derivation definition. Examples of coded processes are described in more detail above with respect to FIG. 1 and below with respect to FIG. 6. Similarly to the rulesets described above, the coded processes may be selected or edited from predefined processes or created as part of method 300.

At 312, the method includes determining a sequence order for the configured rulesets and/or coded processes. The sequence order may define how the rulesets and/or coded processes are applied. At 314, the method includes storing the definition in a repository. For example, the derivation definition configured as described at 302-312 may be stored as data in a centralized repository for later retrieval.

At 316, the method includes calculating a footprint using the derivation definition. For example, at 318, the derivation definition may be retrieved from the repository (e.g., responsive to receipt of user input requesting the selected derivation definition to be applied). At 320, the method includes fetching data corresponding to inputs for the retrieved derivation definition, and at 322, the method includes applying the rulesets and/or coded processes for the derivation definition in the sequence order determined at 312. At 324, the method includes outputting an indication of the calculated footprint (e.g., displaying the result of the calculation in a user interface). It is to be understood that in some examples, the calculation of the footprint may utilize different systems and/or computing resources than the configuring of the derivation definition.

### Example User Interface

FIG. 4 shows example user interface 400 for utilizing the derivation framework of FIG. 1 to derive derivation definitions and perform footprint calculations. For example, the user interface 400 may be used during the execution of method 300 of FIG. 3. To reduce any loss in translation between the Sustainability Business Expert and IT Expert the entire derivation may be visually represented as a footprint derivation diagram 402 in user interface 400, thereby reducing the learning curve to mass roll out the solution involving different departments in an enterprise. For example, diagram 402 provides a representation of inputs 404 used for a selected derivation definition (e.g., business activity metrics, such as a quantity of direct material purchase with derived classification scheme at period, company, plant, supplier granularity in the illustrative example), components 406 of the derivation definition (e.g., search sequence rulesets and footprint calculations in the illustrative example), and outputs 408 of the selected derivation definition (e.g., derived absolute footprint in the illustrative example). The representations 404-408 may be selectable in some examples to allow a user to edit the associated features of the derivation definition. For example, selecting the search sequence component 406 may trigger the user interface 400 to display an editing window that provides an interface for editing the search sequence ruleset. Additional user interface elements may be included in user interface 400 and/or related windows for adding, editing, and/or deleting features of the derivation definition (e.g., adding a new ruleset, changing a sequence for the derivation definition, removing inputs, etc.). The user interface 400 may also include a navigation window 410 for selecting derivation definitions and/or templates to edit and/or for creating new derivation definitions and/or templates.

### Example Architecture

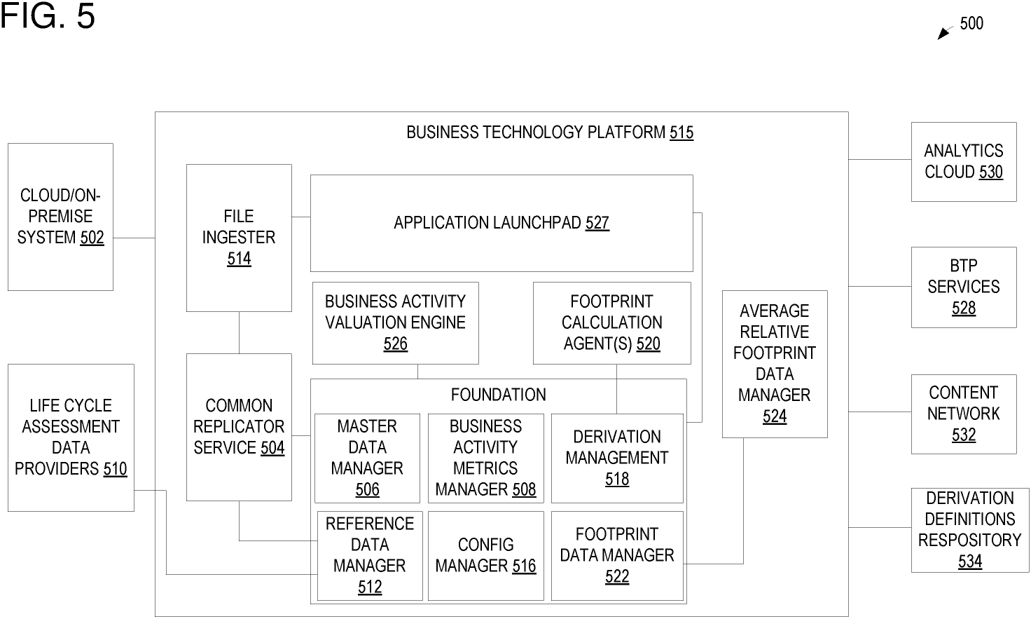

FIG. 5 shows an example computer architecture of a system 500 that may be used to implement the technologies described herein. A cloud or on-premise system may act as a source system for the data described herein. The data used by the system may include Master/config data (e.g., company code, product, suppliers, etc.), where snapshots of this data are replicated by Common Replication Service (CRS) 504 into target persistence for a master/config service known as Master Data Manager (MDM) 506. The data may also include aggregated business activity metrics data (e.g., production orders, goods movement documents, etc.), where periodic delta/changes of these data are replicated by Common Replication Service (CRS) into target persistence for Business Activity Metrics (BAM) Data Manager service 508. As protocol for the replication, Open Data Protocol (OData) may be selected in some examples. In an exemplary implementation, CRS uses the public OData endpoints exposed by an ERP system, such as S/4 HANA, and along with Cloud Data Integration (CDI) views as OData endpoints, where these CDI views (either reused existing views or views created specifically for PFM use cases) are used for extracting master data and BAM data.

Lifecycle Assessment (LCA) data providers 510 provide the emission factors data as Sustainability Reference Content for products which are extracted, transformed and persisted in a reference format in a Sustainability Content Manager of Reference data manager 512. Customers of PFM can also bring in the reference emission factors data (Sustainability Reference Content) in a reference format and upload this data via File Ingestor (FI) service 514 of a business technology platform 515. The same mechanism can be applied for the supplier’s reference emission factors.

A Configuration Manager service 516 manages all the application, system, and customer defined configuration data such as Footprint Categories, Assessment definitions and so on. A Derivation Management 518 manages the definition of derivations as design time artifacts and it also has an Orchestrator which is runtime for execution of derivation which involves a Determination Engine which finds a best match of emission factors based on the user defined search criteria for the business data and Derivation Engine which orchestrates the different Calculation Agents or Engines with all the requested data fetching and sequencing different calculations. For example, derivation management 518 may utilize rulesets to determine and/or select a derivation definition (e.g., to populate/manage and/or select from a centralized derivation definition repository 534) and process assessment data objects to perform customized calculations of footprints as described above with respect to FIGS. 1-4.

Calculation Agents or Engines 520 are the services which executes the calculation/derivation algorithms (e.g., generated as described above with respect to FIGS. 1-3) on the data provided as input and outputs the relative and total footprints. A Footprint Data Manager (FDM) 522 is the repository for all kinds of footprints calculated by different calculation agents or engines and the footprints can be visualized in a ‘View Product Footprints’ application. An Average Relative Footprint Data Manager service 524 is built for calculating the Average Relative footprints.

A Business Activity Valuation Engine (BVE) 526 is the Orchestrator service which executes an assessment for a period based on business scoping like master data and BAM data, on footprint scope like CO2e to derive relative, total and average relative footprints by derivation management service and average relative footprint data manager services. A Foundation Umbrella service manages database access and the DB artifacts per tenant which is shared by foundation services like Master Data, FDM etc. An application launchpad 527 may be used to launch various application of the business technology platform, such as uploading business data, managing assessments, managing deviations, managing configurations, viewing product footprints, defining business scoping, viewing product footprint analytics, etc.

BTP services 528 may be used to realize features, such as:

Application, Audit, and Business Logging services, which are used to handle the related logging operations for tracing, auditing and business logs. An ERP Cloud may be used as a persistent storage for data and an Object Store service may be used for handling objects like zip files, CSV files, and so on.

Personal Data Manager and Retention Manager, which are used to handle the Data Privacy and Data lifecycle management related features.

Identity Provider Service (e.g., for user and role management), which is used for authentication and authorization.

SaaS Provisioning for tenant provision and deprovision features.

Analytics Cloud 530 is used for analytical reporting for slicing and dicing the footprints data with related business data for insights on footprints An ERP Integration component in an ERP system may act as a cache for footprints which can be accessed via APIs and the related UIs and also enables Line-of-Business (LoB) applications like Purchase Order to integrate footprints data for the products. A Content Network 532 includes a network of companies that can publish/consume the calculated footprints by trusted companies.

### Further Implementation Examples

FIG. 6 is an illustrative example of a derivation pattern 600 for footprint derivation according to the present disclosure. For example, the derivation pattern 600 may correspond to a derivation definition, such as derivation definition 104 of FIG. 1, used in calculating a footprint. In the illustrative example of FIG. 6, a derivation X 602 may be used to derive a footprint, such as CO₂e (carbon dioxide equivalent) for purchasing business activities metrics. The derivation X 602 may input to physical goods movement inflow 616 and outflow 620 data and may reference sustainability reference data 618 and average relative footprint data 622 when executing sequences, as described in more detail below.

Calling derivation X 602 may trigger the execution of a first sequence defined by ruleset X 604, which includes executing, in sequence, rule Y 606, rule Z 608, and rule A 610. For example, ruleset X 604 may be a search ruleset for a direct material factor best match search sequence. Each of rules Y, Z, and A may be a respective condition table rule type, which associates attributes and/or characteristics of business activity metric data with sustainability reference data. In the illustrated example, the association for rule Y 606 may relate to material number, supplier, supplier manufacturing country, and/or supplier shipping country. The association for rule Z 608 may be in relation to material number, supplier, and supplier shipping country. The association for rule A 610 may be in relation to a material group. As illustrated, the rules may be applied in order (e.g., rule Y in a first sequence, rule Z in a second sequence, and rule A in a third sequence).

Once ruleset X 604 is applied, in a next sequence, a first coded procedure or method (e.g., for inflow) 612 may be performed. For example, the coded procedure 612 may be performed to convert factor to footprint for inflow purchased material, and may be a post processing method type. In this example, an infosetid matched in a condition table may be used to pull up factor(s) from sustainability reference data 618 based on the type of information and to derive a footprint based on business activity metric material quantity.

In a next sequence (e.g., following the first coded procedure), a second coded procedure or method (e.g., for outflows) 614 may be performed. For example, the coded procedure 614 may be performed to calculate a footprint for outflows, and may be a post processing method type. In this example, an average relative footprint period may be used to calculate the absolute footprint of all outflows. The result of the derivation X 602 execution (e.g., the execution of all sequences related thereto) may be provided to one or more data objects relating to an absolute footprint mix for inflow and outflows 624. As noted above, the flow and description of FIG. 6 is provided as an illustrative description of just one example of implementing derivation for business activity footprint indicators to compute the footprint impact at a period, plant, product, supplier granularity. It is to be understood that other arrangements/combinations of rules/rulesets/coded procedures may be executed for other examples of derivations for footprints without departing from the scope of this disclosure.

When processing primary data related to business processes covering the cradle to outbound gate of pre-chain, the volume and variety of data is typically high, and to map it to suitable sustainability reference data according to other approaches is a tedious task which may utilize a large amount of human work hours and might be even error prone. The approaches described in the present disclosure may address potential bottlenecks while scaling the large-scale mass footprint assessment involving thousands of raw materials or semi-finished products that are purchased from external business partners through the functionality of the search ruleset. For example, the search ruleset enables organizing the search strategies from specialization to generalization, enabling the best possible match for a product based on a condition key composed of characteristics such as (in an illustrative example): a) Product ID, Supplier ID, Supplier Plant Originating Country, Receiving Plant; b) Product Group, Supplier Plant Originating Country, Receiving Plant; c) Material HS Code, Supplier Country. The condition keys may be customizable based on derivation interface assessment data object attributes.

The above provides an example of applying a bottom up calculation strategy to avoid bottlenecks. In another example, the disclosed framework also supports top down allocation, in which a decision table rule can be used to allocate by fixed percentage based on energy needs to produce product at a plant by disaggregating/breaking down a utility bill for energy at multiple dimensions using a chain of derivations (e.g., multiple derivation definitions, applied in sequence). For example, using a first derivation, elementary flow from a company utility bill to plant(s) may be allocated; using a second derivation, energy utilized for a finished product produced from the plant(s) may be allocated; and using a third derivation, climate change may be derived based on energy utilized per product produced in the plant(s).

### Example Advantages

This solution is superior in comparison of approaches in the past with regards to at least the following considerations. The disclosed derivation definitions and associated framework/processing allows for reusability of business rules across different footprint governance initiatives within an organization or company. This reduces cost of development, while offering tools for sustainability experts to configure and reducing IT workload. Derivation definitions may also act as an interface enabling third party providers to offer an implementation with their own extension logic for footprint derivations. This provides an in-built solution extensibility that protects the consistency of the overall footprint assessment engine while enabling customers and partners to cover any derivation patterns not provided by a managing system.

Additionally, in examples of the disclosed technologies, a derivation definition repository is built as content rather than code, which enables distribution of the configurations across the software landscape for more efficient life cycle management. The derivation definition may also offer a business vocabulary that is tailored for a selected business activity category of an end-to-end value chain stage of footprint assessment. The vocabulary or field catalog may offer a domain-specific language for end users such as sustainability experts to express business rules for deriving a product footprint.

### A Generalized Computer Environment

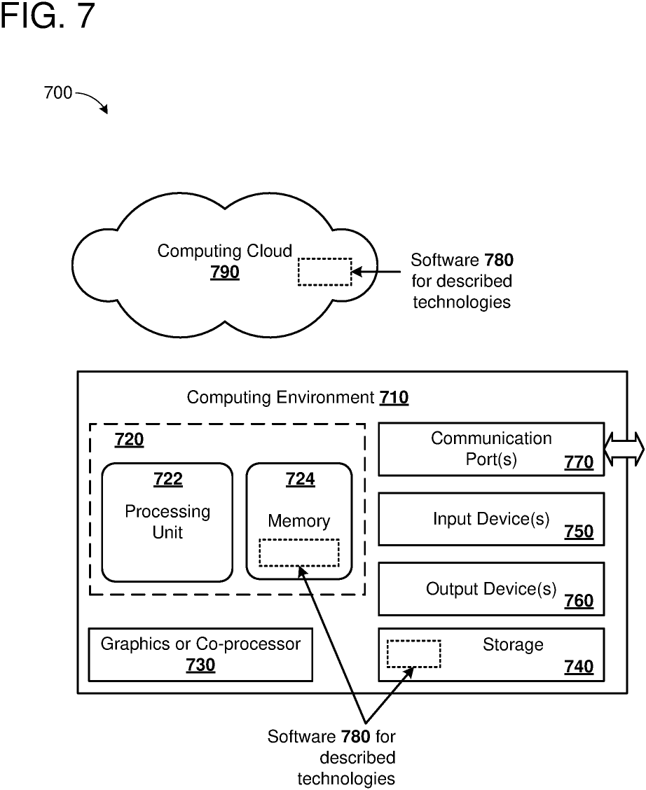

FIG. 7 illustrates a generalized example of a suitable computing system 700 in which described examples, techniques, and technologies, including calculating sustainability footprints according to disclosed technologies can be implemented. The computing system 700 is not intended to suggest any limitation as to scope of use or functionality of the present disclosure, as the innovations can be implemented in diverse general-purpose or special-purpose computing systems.

With reference to FIG. 7, computing environment 710 includes one or more processing units 722 and memory 724. In FIG. 7, this basic configuration 720 is included within a dashed line. Processing unit 722 executes computer-executable instructions, such as for implementing any of the methods or objects described herein for performing queries on a composite graph data structure representing a dynamic system, or various other architectures, components, handlers, managers, modules, or services described herein. Processing unit 722 can be a general-purpose central processing unit (CPU), a processor in an application-specific integrated circuit (ASIC), or any other type of processor. In a multi-processing system, multiple processing units execute computer-executable instructions to increase processing power. Computing environment 710 can also include a graphics processing unit or co-processing unit 730. Tangible memory 724 can be volatile memory (e.g., registers, cache, or RAM), non-volatile memory (e.g., ROM, EEPROM, or flash memory), or some combination thereof, accessible by processing units 722, 730. The memory 724 stores software 780 implementing one or more innovations described herein, in the form of computer-executable instructions suitable for execution by the processing unit(s) 722, 730. The memory 724 can also store footprint calculation data, a composite graph data structure, including nodes, edges, and their respective attributes; a table or other data structure indicating states of a modeled system, configuration data, UI displays, browser code, data structures including data tables, working tables, change logs, output structures, input fields, output fields, data values, indices, or flags, as well as other operational data.

A computing system 710 can have additional features, such as one or more of storage 740, input devices 750, output devices 760, or communication ports 770. An interconnection mechanism (not shown) such as a bus, controller, or network interconnects the components of the computing environment 710. Typically, operating system software (not shown) provides an operating environment for other software executing in the computing environment 710, and coordinates activities of the components of the computing environment 710.

The tangible storage 740 can be removable or non-removable, and includes magnetic disks, magnetic tapes or cassettes, CD-ROMs, DVDs, or any other medium which can be used to store information in a non-transitory way and which can be accessed within the computing environment 710. The storage 740 stores instructions of the software 780 (including instructions and/or data) implementing one or more innovations described herein.

The input device(s) 750 can be a mechanical, touch-sensing, or proximity-sensing input device such as a keyboard, mouse, pen, touchscreen, trackball, a voice input device, a scanning device, or another device that provides input to the computing environment 710. The output device(s) 760 can be a display, printer, speaker, optical disk writer, or another device that provides output from the computing environment 710.

The communication port(s) 770 enable communication over a communication medium to another computing device. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, acoustic, or other carrier.

In some examples, computer system 700 can also include a computing cloud 790 in which instructions implementing all or a portion of the disclosed technology are executed. Any combination of memory 724, storage 740, and computing cloud 790 can be used to store software instructions and data of the disclosed technologies.

The present innovations can be described in the general context of computer-executable instructions, such as those included in program modules, being executed in a computing system on a target real or virtual processor. Generally, program modules or components include routines, programs, libraries, software objects, classes, components, data structures, etc. that perform tasks or implement particular abstract data types. The functionality of the program modules can be combined or split between program modules as desired in various embodiments. Computer-executable instructions for program modules can be executed within a local or distributed computing system.

The terms “system,” “environment,” and “device” are used interchangeably herein. Unless the context clearly indicates otherwise, none of these terms implies any limitation on a type of computing system, computing environment, or computing device. In general, a computing system, computing environment, or computing device can be local or distributed, and can include any combination of special-purpose hardware and/or general-purpose hardware and/or virtualized hardware, together with software implementing the functionality described herein. Virtual processors, virtual hardware, and virtualized devices are ultimately embodied in a hardware processor or another form of physical computer hardware, and thus include both software associated with virtualization and underlying hardware.

### Example Cloud Computing Environment

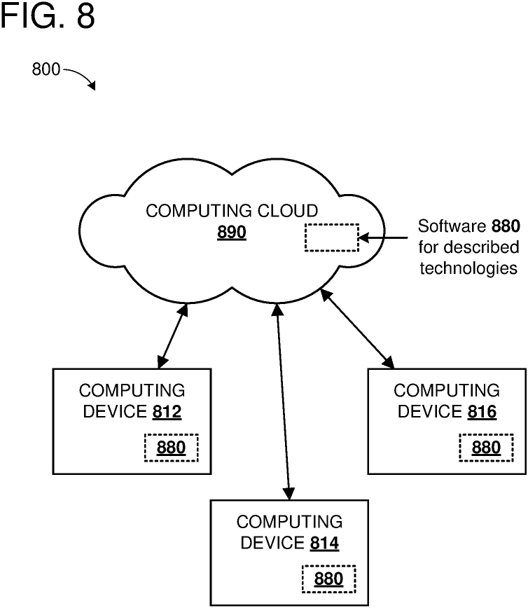

FIG. 8 depicts an example cloud computing environment 800 in which the described technologies can be implemented. The cloud computing environment 800 comprises a computing cloud 890 containing resources and providing services. The computing cloud 890 can comprise various types of cloud computing resources, such as computer servers, data storage repositories, networking resources, and so forth. The computing cloud 890 can be centrally located (e.g., provided by a data center of a business or organization) or distributed (e.g., provided by various computing resources located at different locations, such as different data centers and/or located in different cities or countries).

The computing cloud 890 can be operatively connected to various types of computing devices (e.g., client computing devices), such as computing devices 812, 814, and 816, and can provide a range of computing services thereto. One or more of computing devices 812, 814, and 816 can be computers (e.g., servers, virtual machines, embedded systems, desktop, or laptop computers), mobile devices (e.g., tablet computers, smartphones, or wearable appliances), or other types of computing devices. Communication links between computing cloud 890 and computing devices 812, 814, and 816 can be over wired, wireless, or optical links, or any combination thereof, and can be short-lived or long-lasting. Communication links can be continuous or sporadic. These communication links can be stationary or can move over time, being implemented over varying paths and having varying attachment points at each end. Computing devices 812, 814, and 816 can also be connected to each other.

Computing devices 812, 814, and 816 can utilize the computing cloud 890 to obtain computing services and perform computing operations (e.g., data processing, data storage, and the like). Particularly, software 880 for performing the described innovative technologies can be resident or executed in the computing cloud 890, in computing devices 812, 814, and 816, or in a distributed combination of cloud and computing devices.

### General Considerations

As used in this disclosure, the singular forms “a,” “an,” and “the” include the plural forms unless the surrounding language clearly dictates otherwise. Additionally, the terms “includes” and “incorporates” mean “comprises.” Further, the terms “coupled” or “attached” encompass mechanical, electrical, magnetic, optical, as well as other practical ways of coupling items together, and does not exclude the presence of intermediate elements between the coupled items. Furthermore, as used herein, the terms “or” and “and/or” mean any one item or combination of items in the phrase.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smartphones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 6, computer-readable storage media include memory 624, and storage 640. The term computer-readable storage media does not include signals and carrier waves. In addition, the term computer-readable storage media does not include communication ports (e.g., 670) or communication media.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in ABAP, Adobe Flash, Angular, C, C++, C#, Curl, Dart, Fortran, Go, Java, JavaScript, Julia, Lisp, Matlab, Octave, Perl, Python, R, Ruby, SAS, SPSS, WebAssembly, any derivatives thereof, or any other suitable programming language, or, in some examples, markup languages such as HTML or XML, or in any combination of suitable languages, libraries, and packages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-implemented method comprising:
configuring one or more rulesets to be applied to input data corresponding to operations of an organization to generate a derivation definition for a sustainability footprint calculation relating to the operations;
updating the derivation definition by configuring one or more coded processes to be applied to the input data;
determining a sequence order for the configured one or more rulesets and one or more coded processes for the derivation definition; and
storing the derivation definition in a repository for retrieval by a footprint calculation agent configured to apply the one or more rulesets and one or more coded processes to the input data in the determined sequence order to calculate and output an indication of a sustainability footprint relating to the operations to a graphical user interface.

2. The computer-implemented method of claim 1, wherein the input data includes business activity metric data including inflow and outflow materials.

3. The computer-implemented method of claim 1, wherein the input data includes sustainability reference data including emissions factors.

4. The computer-implemented method of claim 1, wherein the one or more rulesets each comprise one or more respective rules configured to be applied to the input data in a selected sequence order.

5. The computer-implemented method of claim 4, wherein the one or more rulesets include a search ruleset defined by one or more condition table rules, and wherein the one or more condition table rules are configured to associate attributes or characteristics of the input data corresponding to business activity metric data with the input data corresponding to sustainability reference data.

6. The computer-implemented method of claim 4, wherein the one or more rulesets include a calculation flow ruleset defined by one or more disaggregation rules, aggregation rules, decision table rules, or text rules configured to be executed in a sequence.

7. The computer-implemented method of claim 4, wherein the one or more rulesets include an analytical ruleset configured to execute multiple rules of a same result type and return a union of each rule result as a final result.

8. The computer-implemented method of claim 1, wherein the calculated sustainability footprint is provided to one or more computer applications of an Enterprise Resource Planning (ERP) system for adjusting operations of the ERP system to reduce an overall footprint associated with operations managed by the ERP system.

9. The computer-implemented method of claim 1, wherein the one or more coded processes include post processing performed on results of application of the one or more rulesets.

10. The computer-implemented method of claim 1, wherein the derivation definition has a technical interface or signature with an assessment data object as one or more of input, reference, or result.

11. The computer-implemented method of claim 10, wherein the assessment data object has a structural representation or metadata of data points that are used or derived when the sustainability footprint is calculated by the footprint calculation agent.

12. The computer-implemented method of claim 10, wherein the assessment data object is of a structure type or table type, and wherein the assessment data object is flat or nested.

13. One or more computer-readable media storing instructions which, when executed by one or more hardware processors, cause the hardware processors to perform actions comprising:
receiving, via a graphical user interface, first user input identifying input data including a set of emissions factors relating to one or more products and activity data including one or more categories of data relating to operations of an organization;
receiving, via the graphical user interface, second user input configuring one or more rulesets to be applied to the input data, the second user input further specifying a sequence order for the configured one or more rulesets;
computer processing the first and second user input to generate a derivation definition for a sustainability footprint calculation, the derivation definition configured to trigger the one or more rulesets to be applied to the input data in the sequence order to calculate a sustainability footprint relating to the operations of the organization;
storing the derivation definition in a repository; and
transmitting, to a footprint calculation agent, the derivation definition, wherein the footprint calculation agent:
applies the one or more rulesets to the input data in the sequence order to calculate the sustainability footprint in accordance with the derivation definition, and
displays an indication of the sustainability footprint.

14. The one or more computer-readable media of claim 13, wherein the graphical user interface is a first graphical user interface, and wherein the footprint calculation agent is configured to display the indication of the sustainability footprint to a second graphical user interface responsive to a request, received at the second graphical user interface, selecting the derivation definition for use in calculating the sustainability footprint.

15. The one or more computer-readable media of claim 13, wherein the graphical user interface includes a footprint derivation diagram that shows a graphical representation of the input data, the one or more rulesets, and a type of sustainability footprint result, and wherein the graphical representation is selectable to edit the input data, the one or more rulesets, or the type of sustainability footprint result.

16. The one or more computer-readable media of claim 13, wherein the actions further comprise receiving, via the graphical user interface, third user input configuring one or more coded processes to be performed on one or more results of at least one of the one or more rulesets.

17. The one or more computer-readable media of claim 16, wherein the second user input further specifies a sequence order of the one or more coded processes in relation to the one or more rulesets.

18. A system comprising:
one or more hardware processors with memory coupled thereto;
computer-readable media storing instructions executable by the one or more hardware processors, the instructions comprising:
first instructions to receive, via a first graphical user interface displayed on a first computing device, a selection of input data including sustainability reference data, business activity data, or a combination of sustainability reference data and business activity data to be used for a sustainability calculation for an organization;
second instructions to configure one or more rulesets and one or more coded processes to be applied to the input data based on user input received via the first graphical user interface displayed on the first computing device;
third instructions to generate a derivation definition for the sustainability calculation that includes the one or more rulesets and one or more coded processes, the derivation definition including instructions to perform the one or more rulesets and one or more coded processes in a sequence order based on further user input received via the first graphical user interface displayed on the first computing device;
fourth instructions to store the derivation definition in a repository; and
fifth instructions to retrieve, from the repository responsive to a request from a sustainability calculation agent, the derivation definition to cause the sustainability calculation agent to apply the one or more rulesets and one or more coded processes to the input data in the sequence order to calculate and output an indication of a sustainability footprint to a second graphical user interface displayed on a second computing device.

19. The system of claim 18, wherein one or more of the business activity data and the sustainability reference data are provided by a cloud-based computing system.

20. The system of claim 18, wherein the input data further comprises elementary flow metric data and inventory data for the organization.
